(19) United States
(12) Patent Application Publication
(10) Pub. No.: US 2025/0224421 A1
(43) Pub. Date: Jul. 10, 2025

(54) COMPUTER DEVICE AND METHOD FOR EXAMINING A CAPACITIVE SENSOR

(71) Applicant: Robert Bosch GmbH, Stuttgart (DE)

(72) Inventor: Juergen Mueller, Ofterdingen (DE)

(21) Appl. No.: 18/935,926

(22) Filed: Nov. 4, 2024

(30) Foreign Application Priority Data
Jan. 10, 2024 (DE) 10 2024 200 188.0

(51) Int. Cl. G01P 15/125; G01L 9/12; G01P 3/483

(52) U.S. Cl. CPC G01P 15/125; G01L 9/12; G01P 3/483

(57) ABSTRACT

A computer device for a capacitive sensor. The computer device includes an electronic device, wherein the electronic device is designed and/or programmed in such a way that, by means of the electronic device and taking into account at least one first measured variable which is determined or provided when a sensor mass is in its initial position or initial oscillation and relates to a first capacitance between a first electrode and the sensor mass, at least one evaluation variable relating to a spacing of the sensor mass to the first electrode and/or the second electrode and/or relating to a property of the sensor mass and/or the at least one spring component can be defined as at least part of the evaluation information.

### CROSS REFERENCE

The present application claims the benefit under 35 U.S.C. § 119 of German Patent Application No. DE 10 2024 200 188.0 filed on Jan. 10, 2024, which is expressly incorporated herein by reference in its entirety.

### FIELD

The present invention relates to a computer device for a capacitive sensor. The present invention further relates to a capacitive sensor and a measuring cabinet for a production facility. The present invention also relates to a method for examining a capacitive sensor.

### BACKGROUND INFORMATION

Traditionally, after a capacitive sensor has been manufactured, a final test is usually carried out for which at least one test measurement is carried out by means of the capacitive sensor using test equipment that realizes a corresponding test atmosphere and/or test condition, or, as described in German Patent Application No. DE 10 2020 211 308 A1, a respective test situation is simulated by means of at least one non-zero voltage applied to a movable sensor mass of the capacitive sensor or a corresponding substitute stimulus.

### SUMMARY

The present invention creates a computer device for a capacitive sensor, a capacitive sensor, a measuring cabinet for a production facility, and a method for examining a capacitive sensor.

The present invention makes it possible to define/determine at least one sensor-specific evaluation variable of a capacitive sensor without having to carry out a test measurement of the respective capacitive sensor in an artificially created test atmosphere and/or test condition and without having to simulate a corresponding test situation by means of at least one voltage applied to an adjustable sensor mass of the capacitive sensor or a corresponding substitute stimulus. Instead, at most, an example embodiment of the present invention requires determining a first measured variable relating to a first capacitance between a first electrode of the capacitive sensor and the sensor mass and/or a second measured variable relating to a second capacitance between a second electrode of the capacitive sensor and the sensor mass, wherein the first measured variable and the second measured variable are each determined when the sensor mass is in its initial position or initial oscillation. Determining the first measured variable and/or the second measured variable therefore does not require the action of a physical force external to the sensor on the sensor mass and does not require voltage to be applied between the first electrode and the sensor mass and/or between the second electrode and the sensor mass. The first measured variable and the second measured variable can therefore also be determined without the need for specific test equipment as required by the related art. Carrying out the present invention is therefore extremely cost-efficient and can be completed relatively quickly. Moreover, only electronics designed and/or programmed for this purpose are needed to carry out the present invention. There is no need for test equipment when carrying out the present invention.

According to an example embodiment of the present invention, the electronic device is preferably further designed and/or programmed in such a way that the electronic device can be used to define the at least one evaluation variable additionally taking into account at least one second measured variable which is determined or provided when the sensor mass is in its initial position or initial oscillation and relates to a second capacitance between the second electrode and the sensor mass. This can improve the accuracy when defining the at least one evaluation variable.

In one advantageous example embodiment of the computer device of the present invention, the electronic device is further designed and/or programmed in such a way that the electronic device can be used to define at least a first actual distance between the sensor mass and the first electrode, a second actual distance between the sensor mass and the second electrode, a first actual deviation of the first actual distance between the sensor mass and the first electrode from a first target distance between the sensor mass and the first electrode, a second actual deviation of the second actual distance between the sensor mass and the second electrode from a second target distance between the sensor mass and the second electrode, a mean value of the first actual distance and the second actual distance and/or a deflection of the sensor mass from a centered spacing to the first electrode and the second electrode as the at least one evaluation variable. The definition of the first actual distance, the second actual distance, the first actual deviation, the second actual deviation, the mean value of the first actual distance and the second actual distance and/or the deflection of the sensor mass from its centered spacing described here can be carried out using a relatively inexpensive electronic device.

According to an example embodiment of the present invention, the electronic device can alternatively or additionally further be designed and/or programmed in such a way that the electronic device can be used to define at least one etching strength and/or a degree of etching of the sensor mass and/or the at least one spring component as the at least one evaluation variable. The embodiment of the computer device described here can thus determine evaluation variables that are conventionally difficult to obtain with a relatively small amount of effort.

According to an example embodiment of the present invention, the electronic device is preferably further designed and/or programmed in such a way that the electronic device can be used to define at least an average extent of the sensor mass along a spatial direction which extends from the first electrode to the second electrode, a maximum extent of the sensor mass along the spatial direction which extends from the first electrode to the second electrode, a volume of the sensor mass and/or a weight of the sensor mass as the at least one evaluation variable. This makes it possible to determine a large number of sensor-specific evaluation variables relating to the sensor mass of the respective capacitive sensor using the here-described embodiment of the computer device.

According to an example embodiment of the present invention, the electronic device can alternatively or additionally further be designed and/or programmed in such a way that the electronic device can be used to define at least a respective volume of the at least one spring component, a respective weight of the at least one spring component, a respective spring constant of the at least one spring component and/or a total spring constant of a spring-mass system consisting of the sensor mass and the at least one spring component as the at least one evaluation variable. The here-described embodiment of the computer device can thus also be used to reliably define sensor-specific evaluation variables relating to the at least one spring component of the respective capacitive sensor.

In a particularly advantageous embodiment of the computer device of the present invention, the electronic device is further designed and/or programmed in such a way that the electronic device can be used to define at least a natural frequency of the spring-mass system consisting of the sensor mass and the at least one spring component as the at least one evaluation variable. The natural frequency of the spring-mass system consisting of the sensor mass and the at least one spring component can thus be defined by means of the here-described embodiment of the computer device/its electronic device without carrying out a large number of laborious test measurements.

According to an example embodiment of the present invention, the electronic device is preferably further designed and/or programmed in such a way that the electronic device can be used to define at least one sensitivity of the capacitive sensor as the at least one evaluation variable. The sensitivity of the capacitive sensor can thus also be reliably determined without carrying out laborious test measurements using the here-described embodiment of the computer device/its electronic device.

The computer device can be an ASIC, for example. The computer device can therefore also be designed to be comparatively inexpensive and relatively space-saving.

The above-described advantages are also ensured with a capacitive sensor, which is provided with a computer device, the holder, at least the first electrode fastened to and/or in the holder and the sensor mass which is adjustably connected to and/or in the holder by means of the at least one spring component of the capacitive sensor in such a way that the sensor mass can be moved by means of a physical force external to the sensor and/or by means of a non-zero voltage applied between the first electrode and the sensor mass and/or between a second electrode of the capacitive sensor and the sensor mass from an initial position or initial oscillation of the sensor mass.

The capacitive sensor can in particular be an acceleration sensor, a capacitive pressure sensor, or a rotation rate sensor. The present invention described here can therefore be used for commonly used types of sensors. However, the configurability of the capacitive sensor is not limited to the types of sensors listed here.

The above-described advantages are also realized in a measuring cabinet for a production facility with a corresponding computer device according to the present invention.

Furthermore, carrying out a corresponding method according to the present invention for examining a capacitive sensor likewise creates the advantages discussed above. It is expressly noted that the method for examining a capacitive sensor can be further developed in accordance with the above-discussed embodiments of the computer device and/or the capacitive sensor.

### BRIEF DESCRIPTION OF THE DRAWINGS

Further features and advantages of the present invention are explained in the following with reference to the figures.

FIG. 1 shows a schematic illustration of an example embodiment of the computer device or the capacitive sensor interacting with it, according to the present invention.

FIG. 2 shows a flow chart illustrating an example embodiment of the method for examining a capacitive sensor, according to the present invention.

### DETAILED DESCRIPTION OF EXAMPLE EMBODIMENTS

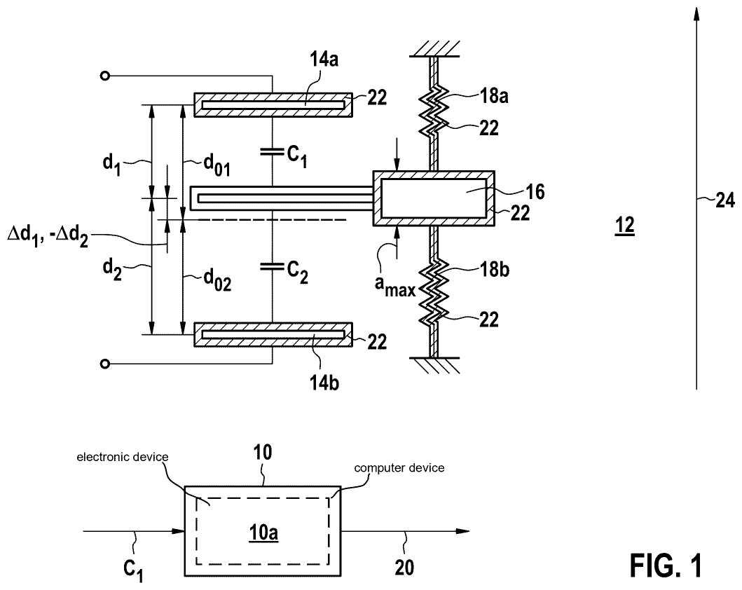

FIG. 1 shows a schematic illustration of an embodiment of the computer device or the capacitive sensor interacting with it.

The computer device 10 shown schematically in FIG. 1 can interact with (almost) any capacitive sensor provided with at least one holder 12, at least a first electrode 14a and possibly a second electrode 14b and a sensor mass 16. The sensor mass 16, the first electrode 14a and possibly also the second electrode 14b are each at least partially made of at least one electrically conductive material. The first electrode 14a and possibly also the second electrode 14b are intended to be understood to be a respective electrode 14a and 14b which is not adjustable/fastened to and/or in the holder 12. The sensor mass 16, on the other hand, refers to an adjustable mass or seismic mass which is adjustably connected to and/or in the holder 12 by means of at least one spring component 18a, 18b of the capacitive sensor in such a way that the sensor mass 16 is or can be moved by means of a physical force external to the sensor and/or by means of a non-zero voltage applied between the first electrode 14a and the sensor mass 16 and/or between the second electrode 14b and the sensor mass 16 from a so-called initial position or initial oscillation of the sensor mass 16. The sensor mass 16 and the at least one spring component 18a and 18b thus form a spring-mass system of the capacitive sensor. The physical force external to the sensor, by means of which the sensor mass 16 is or can be moved from its initial position or initial oscillation, can be understood to be an inertial force, a compressive force or a Coriolis force, for example. The capacitive sensor can thus in particular be an acceleration sensor, a capacitive pressure sensor, or a rotation rate sensor. However, it is expressly noted that a usability of the computer device 10 described in the following is not limited to any specific type of sensor of the capacitive sensor.

Just as an example, the capacitive sensor of FIG. 1 comprises a first tension or compression spring 18a and a second tension or compression spring 18b as the at least one spring component 18a and 18b, wherein the sensor mass 16 is gimbaled between the first tension or compression spring 18a and the second tension or compression spring 18b. However, the configurability of the capacitive sensor that interacts with the computer device 10 is not limited to any specific type of spring of its at least one spring component 18a and 18b.

The capacitive sensor can in particular be a MEMS capacitive sensor (microelectromechanical system) or a micromechanical component. At least the sensor mass 16 and the at least one spring component 18a and 18b can each be components etched out of a starting material, the shape of which can depend upon an etching time and an (actual) etching strength when carrying out the respective etching step. The first electrode 14a and possibly also the second electrode 14b can be formed from at least one electrically conductive material by means of a deposition step and/or a growth step. Alternatively, however, the first electrode 14a and possibly also the second electrode 14b can likewise be components etched out of a starting material, the shape of which can depend upon an etching time and an (actual) etching strength when carrying out the respective etching step.

The computer device 10 can optionally be a subunit of the capacitive sensor or can interact with the capacitive sensor outside the sensor. The computer device 10 can, for instance, also be a subunit of a measuring cabinet of a production facility at which the at least one capacitive sensor is manufactured. The computer device 10 described in the following is therefore versatile. The computer device 10 described in the following can also be an ASIC. The computer device 10 can therefore be manufactured relatively inexpensively. The installation space required for such a computer device 10 is moreover minimized.

The computer device 10 has an electronic device 10a, which is designed and/or programmed in such a way that evaluation information 20 relating to the capacitive sensor can be/is defined by means of the electronic device 10a. The evaluation information 20 is defined by means of the electronic device 10a taking into account at least one measured variable C₁ and C₂ relating to a respective capacitance C₁ and C₂ between the first electrode 14a and the sensor mass 16 and/or between the second electrode 14b and the sensor mass 16. The at least one measured variable C₁ and C₂ can be determined by means of the computer device 10 or a correspondingly designed subunit of the computer device 10, or can be provided to the computer device 10.

The electronic device 10a is furthermore designed and/or programmed in such a way that, by means of the electronic device 10a and taking into account at least one first measured variable C₁ which is determined or provided when the sensor mass 16 is in its initial position or initial oscillation and relates to a first capacitance C₁ between the first electrode 14a and the sensor mass 16, at least one evaluation variable relating to a spacing of the sensor mass 16 to the first electrode 14a and/or the second electrode 14b and/or relating to a property of the sensor mass 16 and/or the at least one spring component 18a, 18b can be/is defined as at least part of the evaluation information 20. The electronic device 10a can optionally also be designed and/or programmed to determine the at least one evaluation variable additionally taking into account at least one second measured variable C₂ which is determined or provided when a sensor mass 16 is in its initial position or initial oscillation. The second measured variable C₂ is intended to be understood to be a measured variable relating to a second capacitance C₂ between the second electrode 14b and the sensor mass 16. Examples of the at least one evaluation variable that can be defined by means of the electronic device 10a are listed in the following.

As the at least one evaluation variable, at least a first actual distance di between the sensor mass 16 and the first electrode 14a, a first actual deviation Δd₁ of the first actual distance d₁ between the sensor mass 16 and the first electrode 14a, and/or a mean value dₘ of the first actual distance di and a second actual distance d₂ between the sensor mass 16 and the second electrode 14b, for example, can be/is defined as at least part of the evaluation information 20. The first actual deviation Δd₁ is intended to be understood to be a deviation of the first actual distance d₁ from a first target distance d₀₁ between the sensor mass 16 and the first electrode 14a (d₁=d₀₁−Δd₁). The mean value dₘ of the first actual distance d₁ and the second actual distance d₂ can be equal to half the sum of the first actual distance d₁ and the second actual distance d₂ (dₘ=(d₁+d₂)/2).

Since at least the first measured variable C₁ is determined when no physical force external to the sensor acts on the sensor mass 16 and no non-zero voltage is applied at least between the first electrode 14a and the sensor mass 16 and possibly also between the second electrode 14b and the sensor mass 16 (because otherwise the sensor mass 16 would not be in its initial position or initial oscillation), if the first actual distance d₁ is equal to the first target distance d₀₁, the first measured variable C₁ would correspond to a specific first measured variable value. A deviation of the first measured variable C₁ from the first measured variable value thus correlates to the first actual deviation Δd₁ of the first actual distance d₁ from the first target distance d₀₁. By means of a comparatively easily executable design/programming of the electronic device 10a, it can therefore be ensured that the first actual distance d₁ and/or the first actual deviation Δd₁ can be defined relatively reliably and comparatively accurately by means of the electronic device 10a taking into account the first measured variable C₁. Since knowledge of the first actual distance d₁ often makes it possible to draw conclusions about the second actual distance d₂, the mean value dₘ of the first actual distance d₁ and the second actual distance d₂ can be reliably determined from the first capacitance C₁ as well.

It is also noted here that the first measured variable C₁ can be measured in a cost-efficient manner without any special effort. Since no physical force external to the sensor has to act on the sensor mass 16 to measure the first measured variable C₁ and there is no need to apply voltage, there is also no need for special and expensive test equipment to measure the first measured variable C₁. The here-described computer device 10 thus realizes a cost-effective and less labor-intensive option for defining/ascertaining at least the first actual distance d₁, the first actual deviation Δd₁ or the mean value dₘ of the first actual distance d₁ and the second actual distance d₂ as at least part of the evaluation information 20.

The first measured variable C₁ can furthermore often already be reliably measured during a manufacturing process of the capacitive sensor when the sensor mass 16, the at least one spring component 18a and 18b, the first electrode 14a and possibly also the second electrode 14b have “just” been formed. The computer device 10 can thus also be used for a preliminary check of the capacitive sensor to be manufactured, so that, if the first actual distance d₁, the first actual deviation Δd₁ and/or the mean value dₘ of the first actual distance d₁ and the second actual distance de are all outside a predetermined normal value range, errors in the manufacturing of the capacitive sensor thus far can be detected early and possibly useless further processing of the capacitive sensor can be avoided. This is a significant advantage of the computer device 10 over conventional options for testing the capacitive sensor only after its completed production.

The electronic device 10a can accordingly also further be designed and/or programmed to determine the second actual distance d₂ between the sensor mass 16 and the second electrode 14b and/or a second actual deviation Δd₂ of the second actual distance d₂ between the sensor mass 16 and the second electrode 14b taking into account at least the second measured variable C₂. The second actual deviation Δd₂ is intended to be understood to be a deviation of the second actual distance d₂ from a second target distance d₀₂ between the sensor mass 16 and the second electrode 14b (d₂=d₀₂−Δd₂). (It is not absolutely necessary that the second actual deviation Δd₂ is equal to the negative of the first actual deviation Δd₁ as suggested in FIG. 1.) If desired, the mean value dₘ of the first actual distance d₁ and the second actual distance de can also be determined as half a sum of the defined first actual distance d₁ and the defined second actual distance d₂. The first measured variable C₁ and the second measured variable C₂ can also be used to reliably determine a deflection of the sensor mass 16 from a centered spacing to the first electrode 14a and the second electrode 14b.

As already explained above, at least the sensor mass 16 and the at least one spring component 18a and 18b can each be components etched out of a starting material. As can be seen from the markings 22 in FIG. 1, not only a respective shape of at least the sensor mass 16 and the at least one spring component 18a and 18b but correspondingly also the first actual distance d₁, the first actual deviation Δd₁, the second actual distance d₂, the second actual deviation Δd₂ and the mean value dₘ of the first actual distance d₁ and the second actual distance d₂ depend on an etching time and an (actual) etching strength when patterning out at least the sensor mass 16 and/or the at least one spring component 18a and 18b. Accordingly, the first measured variable C₁, the second measured variable C₂, the first actual distance d₁, the first actual deviation Δd₁, the second actual distance d₂, the second actual deviation Δd₂ and the mean value dₘ of the first actual distance d₁ and the second actual distance d₂ are variables that make it possible to draw conclusions about the etching time and the (actual) etching strength when patterning out at least the sensor mass 16 and/or the at least one spring component 18a and 18b. The electronic device 10a can therefore also be designed and/or programmed to define at least one etching strength and/or a degree of etching of the sensor mass 16 and/or the at least one spring component 18a and 18b as the at least one evaluation variable.

The first measured variable C₁, the second measured variable C₂, the first actual distance d₁, the first actual deviation Δd₁, the second actual distance d₂, the second actual deviation Δd₂ and the mean value dₘ of the first actual distance d₁ and the second actual distance d₂ also make it possible to draw conclusions about the shape (actually) realized by patterning out at least the sensor mass 16 and the at least one spring component 18a and 18b and correspondingly also about the properties of at least the sensor mass 16 and the at least one spring component 18a and 18b resulting from their shape. An easily executable design and/or programming therefore also makes it possible to further develop the electronic device 10a to define at least an average extent of the sensor mass 16 along a spatial direction 24 which extends from the first electrode 14a to the second electrode 14b, a maximum extent aₘₐₓ of the sensor mass 16 along the spatial direction 24 which extends from the first electrode 14a to the second electrode 14b, a volume of the sensor mass 16 and/or a weight/mass m₁₆ of the sensor mass 16 as the at least one evaluation variable. The average extent of the sensor mass, the maximum extent aₘₐₓ of the sensor mass 16, the volume of the sensor mass 16 and/or the weight/the mass m₁₆ of the sensor mass 16 can easily be defined by means of the electronic device 10a taking into account the first measured variable C₁, the second measured variable C₂, the first actual distance d₁ between the sensor mass 16 and the first electrode 14a, the first actual deviation Δd₁ of the first actual distance d₁ from the first target distance d₀₁, the second actual distance de between the sensor mass 16 and the second electrode 14b, the second actual deviation Δd₂ of the second actual distance d₂ from the second target distance d₀₂ and/or the mean value dm of the first actual distance d₁ and the second actual distance d₂. Sensor-specific data relating to the sensor mass 16 of the capacitive sensor can thus easily be obtained by means of the electronic device 10a.

An easily executable design and/or programming accordingly also makes it possible to configure the electronic device 10a to define at least one respective volume of the at least one spring component 18a and 18b, a respective weight/respective mass of the at least one spring component 18a and 18b, a respective spring constant of the at least one spring component 18a and 18b and/or a total spring constant k_{H} of the spring-mass system consisting of the sensor mass 16 and the at least one spring component 18a and 18b as the at least one evaluation variable. (The total spring constant k_{H} of the spring-mass system is sometimes also referred to as Hooke's constant.) If necessary, the respective volume of the at least one spring component 18a and 18b, the respective weight/the respective mass of the at least one spring component 18a and 18b, the respective spring constant of the at least one spring component 18a and 18b and/or the total spring constant k_{H} of the spring-mass system are defined by means of the electronic device 10a taking into account the first measured variable C₁, the second measured variable C₂, the first actual distance d₁ between the sensor mass 16 and the first electrode 14a, the first actual deviation Δd₁ of the first actual distance d₁ from the first target distance d₀₁, the second actual distance de between the sensor mass 16 and the second electrode 14b, the second actual deviation Δd₂ of the second actual distance d₂ from the second target distance d₀₂ and/or the mean value dₘ of the first actual distance d₁ and the second actual distance d₂. The electronic device 10a can thus also be used to obtain sensor-specific data relating to the at least one spring component 18a and 18b of the capacitive sensor without having to carry out complicated measurements.

In another advantageous embodiment, the electronic device 10a is further designed and/or programmed in such a way that at least a natural frequency f₀ of the spring-mass system consisting of the sensor mass 16 and the at least one spring component 18a and 18b can be/is defined by means of the electronic device 10a as the at least one evaluation variable as part of the evaluation information 20. The natural frequency f₀ of the spring-mass system, too, can be defined by means of the electronic device 10a taking into account the first measured variable C₁, the second measured variable C₂, the first actual distance d₁ between the sensor mass 16 and the first electrode 14a, the first actual deviation Δd₁ of the first actual distance d₁ from the first target distance d₀₁, the second actual distance de between the sensor mass 16 and the second electrode 14b, the second actual deviation Δd₂ of the second actual distance d₂ from the second target distance d₀₂, the mean value dₘ of the first actual distance d₁ and the second actual distance d₂, the average extent of the sensor mass 16 along a spatial direction 24 which extends from the first electrode 14a to the second electrode 14b, the maximum extent aₘₐₓ of the sensor mass 16 along the spatial direction 24 which extends from the first electrode 14a to the second electrode 14b, the volume of the sensor mass 16, the weight/the mass m₁₆ of the sensor mass 16, the respective volume of the at least one spring component 18a and 18b, the respective weight/the respective mass of the at least one spring component 18a and 18b, the respective spring constant of the at least one spring component 18a and 18b and/or the total spring constant k_{H} of the spring-mass system, because the variables listed here make it possible to draw conclusions about the natural frequency f₀ of the spring-mass system. The natural frequency f₀ of the spring-mass system can in particular be defined by means of the electronic device 10a using the equation (Eq. 1) with:

$${f}_{0} = \sqrt{\frac{{k}_{H}}{{m}_{16}}} \qquad ( Eq . 1 )$$

The electronic device 10a can advantageously be further designed and/or programmed in such a way that at least one sensitivity S of the capacitive sensor can be/is defined by means of the electronic device as the at least one evaluation variable. The sensitivity S of the capacitive sensor can be reliably defined by in particular taking into account the first measured variable C₁, the second measured variable C₂, the first actual distance d₁ between the sensor mass 16 and the first electrode 14a, the first actual deviation Δd₁ of the first actual distance d₁ from the first target distance d₀₁, the second actual distance de between the sensor mass 16 and the second electrode 14b, the second actual deviation Δd₂ of the second actual distance de from the second target distance d₀₂, the mean value dₘ of the first actual distance d₁ and the second actual distance d₂, the average extent of the sensor mass 16 along the spatial direction 24 which extends from the first electrode 14a to the second electrode 14b, the maximum extent aₘₐₓ of the sensor mass 16 along the spatial direction 24 which extends from the first electrode 14a to the second electrode 14b, the volume of the sensor mass 16, the weight/the mass m₁₆ of the sensor mass 16, the respective volume of the at least one spring component 18a and 18b, the respective weight/the respective mass of the at least one spring component 18a and 18b, the respective spring constant of the at least one spring component 18a and 18b, the total spring constant k_{H} of the spring-mass system and/or the natural frequency f₀ of the spring-mass system. The sensitivity S of the capacitive sensor can, for example, be defined by means of the electronic device 10a using equation (Eq. 2) with:

$$S = \frac{1}{{d}_{m}} * \frac{{m}_{16}}{{k}_{H}} = \frac{1}{4 {π}^{2} {d}_{m}} * \frac{1}{{f}_{0}^{2}} \qquad ( Eq . 2 )$$

The evaluation variables that can be reliably and accurately determined as evaluation information 20 by means of the computer device 10/its electronic device 10a are significant properties of the capacitive sensor. This knowledge makes it possible to then operate the capacitive sensor in such a way that at least one physical measured variable, such as an acceleration and/or a rotation rate, to be measured by the capacitive sensor can be determined with a comparatively high degree of accuracy and with a relatively low error rate.

The computer device 10 can also advantageously be used for a spring-mass system with a more complex structure. If necessary, calculation rules corresponding to equations (Eq. 1) and (Eq. 2) can be used to obtain structural information and, if desired, to draw conclusions about a respective asymmetry and/or a respective sensitivity S. The comparatively simple structure of the capacitive sensor shown in FIG. 1 should therefore be interpreted merely as an example. Since calculation rules corresponding to equations (Eq. 1) and (Eq. 2) are described in the related art, they will not be discussed in more detail here.

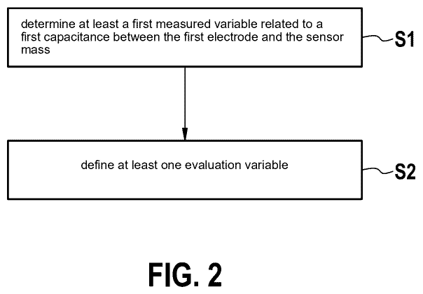

FIG. 2 shows a flow chart illustrating an embodiment of the method for examining a capacitive sensor.

When carrying out the method discussed here, evaluation information is defined taking into account at least one determined measured variable. The at least one determined measured variable is intended to be understood to be a variable relating to a respective capacitance between at least one first electrode and/or second electrode of the capacitive sensor fastened to and/or in a holder of the capacitive sensor and a sensor mass of the capacitive sensor, wherein the sensor mass is adjustably connected to and/or in the holder by means of at least one spring component of the capacitive sensor in such a way that the sensor mass can be/is moved by means of a physical force external to the sensor and/or by means of a non-zero voltage applied between the first electrode and the sensor mass and/or between the second electrode and the sensor mass from an initial position or initial oscillation of the sensor mass. Examples of the physical force external to the sensor have already been listed above.

The method comprises a method step S1, in which at least a first measured variable relating to a first capacitance between the first electrode and the sensor mass is determined when the sensor mass is in its initial position or initial oscillation. In a subsequent method step S2, at least one evaluation variable relating to a spacing of the sensor mass to the first electrode and/or the second electrode and/or relating to a property of the sensor mass and/or the at least one spring component is defined as at least part of the evaluation information taking into account at least the determined first measured variable. Examples of the at least one evaluation variable have already been listed above. The here-described method therefore also provides the above-discussed advantages, wherein the method can be further developed in accordance with the example of the computer device of FIG. 1.

What is claimed is:

1. A computer device for a capacitive sensor, comprising:
an electronic device configured in such a way that the electronic device can be used to define evaluation information taking into account at least one measured variable, which is determined by the computer device or is provided to the computer device and relates to a respective capacitance between: (i) at least one first electrode and/or second electrode of the capacitive sensor fastened to and/or in a holder of the capacitive sensor and (ii) a sensor mass of the capacitive sensor which is adjustably connected to and/or in the holder by at least one spring component of the capacitive sensor in such a way that the sensor mass can be moved using a physical force external to the sensor and/or using a non-zero voltage applied: (a) between the first electrode and the sensor mass and/or (b) between the second electrode and the sensor mass from an initial position or initial oscillation of the sensor mass;
wherein the electronic device is configured in such a way that, using the electronic device and taking into account the at least one first measured variable which is determined or provided when the sensor mass is in its initial position or initial oscillation and relates to a first capacitance between the first electrode and the sensor mass, at least one evaluation variable can be defined as at least part of the evaluation information: (i) relating to a spacing of the sensor mass to the first electrode and/or the second electrode and/or (ii) relating to a property of the sensor mass and/or the at least one spring component.

2. The computer device according to claim 1, wherein the electronic device is further configured in such a way that the electronic device can be used to define the at least one evaluation variable additionally taking into account at least one second measured variable which is determined or provided when the sensor mass is in its initial position or initial oscillation, and relates to a second capacitance between the second electrode and the sensor mass.

3. The computer device according to claim 1, wherein the electronic device is further configured in such a way that the electronic device can be used to define, at the at least one evaluation variable: (i) at least a first actual distance between the sensor mass and the first electrode, and/or (ii) a second actual distance between the sensor mass and the second electrode, and/or (iii) a first actual deviation of the first actual distance between the sensor mass and the first electrode from a first target distance between the sensor mass and the first electrode, and/or (iv) a second actual deviation of the second actual distance between the sensor mass and the second electrode from a second target distance between the sensor mass and the second electrode, and/or (v) a mean value of the first actual distance and the second actual distance, and/or (vi) a deflection of the sensor mass from a centered spacing of the first electrode to the second electrode.

4. The computer device according to claim 1, wherein the electronic device is further configured in such a way that the electronic device can be used to define, at the at least one evaluation variable: (i) at least one etching strength and/or (ii) a degree of etching of the sensor mass and/or (iii) the at least one spring component.

5. The computer device according to claim 1, wherein the electronic device is configured in such a way that the electronic device can be used to define, as the at least one evaluation variable: (i) at least an average extent of the sensor mass along a spatial direction which extends from the first electrode to the second electrode, (ii) a maximum extent of the sensor mass along the spatial direction which extends from the first electrode to the second electrode, (iii) a volume of the sensor mass, and/or (iv) a weight of the sensor mass.

6. The computer device according to claim 1, wherein the electronic device is further configured in such a way that the electronic device can be used to define, at the at least one evaluation variable, at least a respective volume of the at least one spring component, and/or a respective weight of the at least one spring component, and/or a respective spring constant of the at least one spring component, and/or (iv) a total spring constant of a spring-mass system including sensor mass and the at least one spring component.

7. The computer device according to claim 1, wherein the electronic device is further configured in such a way that the electronic device can be used to define, at the at least one evaluation variable at least a natural frequency of spring-mass system including the sensor mass and the at least one spring component.

8. The computer device according to claim 1, wherein the electronic device is further configured in such a way that the electronic device can be used to define, as the at least one evaluation parameter, at least one sensitivity of the capacitive sensor.

9. The computer device according to claim 1, wherein the computer device is an ASIC.

10. A capacitive sensor comprising:
a computer device including:
an electronic device configured in such a way that the electronic device can be used to define evaluation information taking into account at least one measured variable, which is determined by the computer device or is provided to the computer device and relates to a respective capacitance between: (i) at least one first electrode and/or second electrode of the capacitive sensor fastened to and/or in a holder of the capacitive sensor and (ii) a sensor mass of the capacitive sensor which is adjustably connected to and/or in the holder by at least one spring component of the capacitive sensor in such a way that the sensor mass can be moved using a physical force external to the sensor and/or using a non-zero voltage applied: (a) between the first electrode and the sensor mass and/or (b) between the second electrode and the sensor mass from an initial position or initial oscillation of the sensor mass,
wherein the electronic device is configured in such a way that, using the electronic device and taking into account the at least one first measured variable which is determined or provided when the sensor mass is in its initial position or initial oscillation and relates to a first capacitance between the first electrode and the sensor mass, at least one evaluation variable can be defined as at least part of the evaluation information: (i) relating to a spacing of the sensor mass to the first electrode and/or the second electrode and/or (ii) relating to a property of the sensor mass and/or the at least one spring component;
the holder;
at least the first electrode fastened to and/or in the holder; and
the sensor mass which is adjustably connected to and/or in the holder using the at least one spring component of the capacitive sensor in such a way that the sensor mass can be moved using the physical force external to the sensor and/or using the non-zero voltage applied: (i) between the first electrode and the sensor mass and/or (ii) between the second electrode of the capacitive sensor and the sensor mass from an initial position or initial oscillation of the sensor mass.

11. The capacitive sensor according to claim 10, wherein the capacitive sensor is an acceleration sensor or a capacitive pressure sensor or a rotation rate sensor.

12. A measuring cabinet for a production facility, comprising:
a computer device including:
an electronic device configured in such a way that the electronic device can be used to define evaluation information taking into account at least one measured variable, which is determined by the computer device or is provided to the computer device and relates to a respective capacitance between: (i) at least one first electrode and/or second electrode of the capacitive sensor fastened to and/or in a holder of the capacitive sensor and (ii) a sensor mass of the capacitive sensor which is adjustably connected to and/or in the holder by at least one spring component of the capacitive sensor in such a way that the sensor mass can be moved using a physical force external to the sensor and/or using a non-zero voltage applied: (a) between the first electrode and the sensor mass and/or (b) between the second electrode and the sensor mass from an initial position or initial oscillation of the sensor mass;
wherein the electronic device is configured in such a way that, using the electronic device and taking into account the at least one first measured variable which is determined or provided when the sensor mass is in its initial position or initial oscillation and relates to a first capacitance between the first electrode and the sensor mass, at least one evaluation variable can be defined as at least part of the evaluation information: (i) relating to a spacing of the sensor mass to the first electrode and/or the second electrode and/or (ii) relating to a property of the sensor mass and/or the at least one spring component.

13. A method for examining a capacitive sensor, comprising:
defining evaluation information taking into account at least one determined measured variable, which relates to a respective capacitance between: (i) at least one first electrode and/or second electrode of the capacitive sensor fastened to and/or in a holder of the capacitive sensor and (ii) a sensor mass of the capacitive sensor which is adjustably connected to and/or in the holder using at least one spring component of the capacitive sensor in such a way that the sensor mass can be moved: (i) by a physical force external to the sensor and/or (ii) by a non-zero voltage applied: (a) between the first electrode and the sensor mass and/or (b) between the second electrode and the sensor mass, from an initial position or initial oscillation of the sensor mass; and
taking into account at least one first measured variable which is determined when a sensor mass is in its initial position or initial oscillation and relates to a first capacitance between the first electrode and the sensor mass, at least one evaluation variable relating to: (i) a spacing of the sensor mass to the first electrode and/or the second electrode and/or (ii) with respect to a property of the sensor mass and/or the at least one spring component, is defined as at least part of the evaluation information.
